(19) United States
(12) Patent Application Publication
(10) Pub. No.: US 2024/0040999 A1
(43) Pub. Date: Feb. 8, 2024

(54) PET COVERING DEVICE

(71) Applicants: Janet Braswell, Lees Summit, MO (US); Gary Braswell, Lees Summit, MO (US)

(72) Inventors: Janet Braswell, Lees Summit, MO (US); Gary Braswell, Lees Summit, MO (US)

(21) Appl. No.: 18/363,776

(22) Filed: Aug. 2, 2023

Related U.S. Application Data
(60) Provisional application No. 63/395,069, filed on Aug. 4, 2022.

(51) Int. Cl. A01K 13/00; A01K 23/00

(52) U.S. Cl. CPC A01K 13/006; A01K 23/00

(57) ABSTRACT

The present invention relates to a novel pet cover device. The device is a protective covering for a dog or other pet to prevent the dog or other pet from shedding on vehicle upholstery. The device comprises a loose fitting elastic drawstring bag component having four leg openings and a neck opening. The bag component slides up over the dog's legs and torso, then up to the dog's neck area, where it is tightened with the drawstring mechanism. The bag component is gathered at the leg openings to remain tight or formed to the dog's legs. Once in place, the user may tie and/or apply hook and loop fasteners to firmly secure the bag component around a dog when needed.

### CROSS-REFERENCE TO RELATED APPLICATION

The present application claims priority to, and the benefit of, U.S. Provisional Application No. 63/395,069, which was filed on Aug. 4, 2022, and is incorporated herein by reference in its entirety.

### FIELD OF THE INVENTION

The present invention relates generally to the field of pet cover devices. More specifically, the present invention relates to an improved pet cover device that provides users with a loose-fitting bag covering for dogs and other pets, designed to prevent shedding in a vehicle while traveling. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet cover devices. Generally, transporting dogs and other pets can be a difficult and messy experience for pet owners. Dogs and other pets will inevitably shed, leaving stray hair all over vehicle seats, that can require extensive vacuuming and cleaning. Further, pet hair blown throughout the vehicle can end up on the dashboard and in air vents. Additionally, some dogs or other pets may enter the vehicle while wet and spread unwanted odors throughout the vehicle.

A garment which will fit all dogs or other pets within certain sizes and protect against shedding hair and dirt on the upholstery of a vehicle is needed. The pet garment should be comfortable, easy to apply, and neat in appearance. Furthermore, the pet garment should maintain full body coverage without inhibiting the pet's movement. As such, a pet cover device that protects a vehicle's seats, while making sure the pet is comfortable is needed.

Therefore, there exists a long-felt need in the art for a pet cover device that provides users with a loose-fitting bag covering for dogs and other pets, designed to prevent shedding in a vehicle. There is also a long-felt need in the art for a pet cover device that allows all shed hair to be collected inside the covering for easy disposal once traveling is complete. Further, there is a long-felt need in the art for a pet cover device that features an elastic drawstring or hook and loop fasteners to comfortably secure the cover over the dog's four legs, up over the torso to the neck. Moreover, there is a long-felt need in the art for a device that reduces the cleaning required after traveling with a pet, preventing unwanted odors from developing within the interior upholstery. Further, there is a long-felt need in the art for a pet cover device that improves cleanliness and ease of travel with a wet dog by keeping moisture and odors contained within the covering. Finally, there is a long-felt need in the art for a pet cover device that offers a way for pets to enjoy traveling with their owners without making an extensive mess.

The subject matter disclosed and claimed herein, in one embodiment thereof, comprises a pet cover device. The device is a protective covering for a dog or other pet to prevent the dog or other pet from shedding on vehicle upholstery. The device comprises a loose fitting elastic drawstring bag component having four leg openings and a neck opening. The bag component slides up over the dog's legs and torso, then up to the dog's neck area, where it is tightened with the drawstring mechanism. The bag component is gathered at the leg openings to remain tight fitting or formed to the dog's legs. Once in place, the user may tie and/or apply hook and loop fasteners to firmly secure the bag component around a dog when needed.

In this manner, the pet cover device of the present invention accomplishes all of the foregoing objectives and provides users with a device that maintains full body coverage for the pet without inhibiting the pet's movement when in the vehicle. The device allows pet owners to travel worry free with their dogs and maintain a clean, sanitary vehicle with minimal cleaning required. The device fits most dogs or other pets and can be manufactured in multiple shapes and styles based on a user's preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet cover device. The device is a protective covering for a dog or other pet to prevent the dog or other pet from shedding on vehicle upholstery while traveling in a vehicle. The device comprises a loose fitting elastic drawstring bag component having four leg openings and a neck opening. The bag component slides up over the dog's legs and torso, then up to the dog's neck area, where it is tightened with the drawstring mechanism.

It is common practice to transport dogs, cats, and other similar pets in vehicles. However, in order to prevent the pets from scratching the upholstery or paint or shedding hairs on the vehicle upholstery, a pet cover device is needed which may be quickly placed over the dog or other pet. The pet cover device is comfortable for the pets, and can accommodate pets of varying sizes and weights, within certain limitations of size, due to the fact that the pet cover device is stretchable therein.

In one embodiment, the pet cover device comprises a bag component which forms a substantially tubular casing for the dog or other pet. The bag component further comprises four leg openings through which the front and rear legs, respectively, of the dog or other pet may extend. Typically, the leg openings extend a few inches down the dog's or other pet's leg. However, the leg openings can be any suitable length as is known in the art depending on the needs and/or wants of a user. In one embodiment, the leg openings extend down the entire length of the dog's or other pet's legs.

In one embodiment, the leg openings comprise elastic around the opening perimeter, such that the bag component remains gathered at the dog's legs to remain tight fitting or formed to the dog's legs when in use. The result of this construction is that when the bag component is placed upon the dog and the leg openings pulled up over the feet, the elastic portions will act as cuffs to encircle the dog's legs with sufficient tension to be comfortable and yet to keep the lower portion of the leg cover around the leg of the dog. The elastic portion also allows the bag component to stretch to accommodate dogs of various lengths, sizes, and shapes. Thus, even when the bag component is placed on the dog, the dog remains comfortable. Further, the leg openings with the elastic portions do not permit the leg coverings to drop off the dog, but still provide the dog with full freedom of movement.

In one embodiment, the leg openings comprise a foot covering which encapsulates the dog's entire foot. The foot coverings are designed to be detachable from the leg openings or can be a unitary structure with the bag component/leg openings and not capable of being removed. The foot coverings cover the animal's feet, such that the claws don't scratch the vehicle seats or paint. A tread or other suitable roughened surface topography can be included on an underside of the foot coverings to allow for traction while the animal is wearing the foot coverings and to avoid slippage.

In one embodiment, the bag component comprises a pliable, plastic cover comprising a body portion terminating at one end in a neck opening arranged to be secured around a dog's neck. The neck opening typically comprises an elastic drawstring and/or hook and loop fasteners which allow a user to secure the neck opening around the neck of a dog or other pet. Further, any suitable fasteners can be utilized depending on the needs and/or wants of a user. Further, the opposite end of the bag component comprises an extension for receiving the tail of an animal.

In one embodiment, the neck opening comprises a hood portion for covering the head of a dog or other pet. The hood portion is designed to be detachable from the neck opening or can be a unitary structure with the bag component and not capable of being removed. The hood portion can also have an elastic element around its periphery to help in retaining the hood to the dog's head.

In operation, the bag component has an outer surface and an inner surface, as well as a front end and a rear end. When the dog steps into the bag component, the dog places its legs through the leg openings, the tubular rear portion of the bag component then extends around the hindquarters of the body of the dog. The tail extends through the rear opening of the bag component, and the bag component then slides over the dog's body/torso, up to the neck area. In this position, the bag component encapsulates the dog's body and is secured at the neck via a drawstring, hook and loop fasteners, or other suitable fasteners as is known in the art. Thus, the bag component allows shed hair to be collected inside the bag component for easy disposal once traveling is complete.

The bag component of the device is particularly advantageous due to its flexibility, waterproof quality, and ease of application to and removal from the dog or other pet. Thus, with the fasteners opened around the neck area, it is simple to insert the legs of the dog into the open bag component, and with a small amount of training, the dog can assist in this operation. It is then only necessary pull the drawstring closed. Removal is even easier, since after separation of the drawstring, the bag component may be moved downwardly and rearwardly off the top of the body and then the legs are moved out of the leg openings. Again, with a minimal amount of training, the dog can facilitate this operation and can step out of the bag component.

In one embodiment, the pet cover device is composed of a flexible material, such as a paper material or a plastic material, or may be composed of an absorbent paper material on the external surface with an inner polymeric liner located within the interior surface for mitigating the risk of leakage of liquid onto the vehicle seats should the animal urinate while wearing the device. If the pet cover device is composed of a polymeric material, such as a thin plastic material, it should be recyclable in nature. Most preferably, the pet cover device is composed of a biodegradable fiber so that the disposable sanitary pet cover device is lightweight, easy to use, and environmentally friendly.

The pet cover device can be a variety of shapes and sizes and can be made from a variety of materials. In some embodiments, the pet cover device can be sized and shaped to fit over small dogs and other pets. In other embodiments, the pet cover device can be sized and shaped to fit over large dogs and other pets. Typically, the pet cover device would be manufactured in small, medium, and large sizes to fit most animals. In some embodiments, the pet cover device can be made of an antimicrobial material to form a bacterial barrier. In one embodiment, for example, the pet cover device can be made of a fabric that can be flexible, elastic, and antimicrobial such as, for example, poly spandex.

In one embodiment, the pet cover device is provided in a sealed container, packaged prior to use in a clean environment. In this regard, the pet cover device is preferably disposed of after a single usage. In another embodiment, the pet cover device can be reusable. In this embodiment, the pet cover device is manufactured of a fabric material that allows the pet cover device to be washed and reused.

In yet another embodiment, the pet cover device comprises a plurality of indicia.

In yet another embodiment, a method of traveling with a pet while still maintaining a clean, sanitary vehicle is disclosed. The method includes the steps of providing a pet cover device comprising a drawstring bag component with four leg openings and a neck opening. The method also comprises sliding the bag component up over the dog's leg and torso and then up to the dog's neck area. Further, the method comprises tightening the drawstring mechanism around a dog's neck. The method also comprises applying hook and loop fasteners to secure the device to the dog. Finally, the method comprises traveling with the dog while wearing the pet cover device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pet cover device of the present invention in use in accordance with the disclosed architecture;

FIGS. 2A-B illustrate a perspective view of a vehicle seat without the pet cover device and a vehicle seat with the pet cover device of the present invention in accordance with the disclosed architecture;

FIG. 3 illustrates a perspective view of one potential embodiment of the pet cover device of the present invention showing how the cover is applied to a dog in accordance with the disclosed architecture;

FIG. 4 illustrates a perspective view of one potential embodiment of the pet cover device of the present invention showing the cover applied comfortably via the drawstring closure in accordance with the disclosed architecture;

FIG. 5 illustrates a perspective view of one potential embodiment of the pet cover device of the present invention showing a close-up view of the cover material in accordance with the disclosed architecture; and

FIG. 6 illustrates a flowchart showing the method of traveling with a pet while still maintaining a clean, sanitary vehicle, in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet cover device that provides users with a loose-fitting bag covering for dogs and other pets designed to prevent shedding in a vehicle. There is also a long-felt need in the art for a pet cover device that allows all shed hair to be collected inside the covering for easy disposal once traveling is complete. Further, there is a long-felt need in the art for a pet cover device that features an elastic drawstring or hook and loop fasteners to comfortably secure the cover over the dog's four legs, up over the torso to the neck. Moreover, there is a long-felt need in the art for a device that reduces the cleaning required after traveling with a pet, preventing unwanted odors from developing within the interior upholstery. Further, there is a long-felt need in the art for a pet cover device that improves cleanliness and ease of travel with a wet dog by keeping moisture and odors contained within the covering. Finally, there is a long-felt need in the art for a pet cover device that offers a way for pets to enjoy traveling with their owners without making an extensive mess.

The present invention, in one exemplary embodiment, is a novel pet cover device. The device is a protective covering for a dog or other pet to prevent the dog or other pet from shedding on vehicle upholstery. The device comprises a loose fitting elastic drawstring bag component having four leg openings and a neck opening. The bag component slides up over the dog's legs and torso, then up to the dog's neck area, where it is tightened with the drawstring mechanism. The bag component is gathered at the leg openings to remain tight fitting or formed to the dog's legs. Once in place, the user may tie and/or apply hook and loop fasteners to firmly secure the bag component around his or her dog. The present invention also includes a novel method of traveling with a pet while maintaining a clean, sanitary vehicle. The method includes the steps of providing a pet cover device comprising a drawstring bag component with four leg openings and a neck opening. The method also comprises sliding the bag component up over the dog's legs and torso and then up to the dog's neck area. Further, the method comprises tightening the drawstring mechanism around a dog's neck. The method also comprises applying hook and loop fasteners to secure the device to the dog. Finally, the method comprises traveling with the dog while wearing the pet cover device.

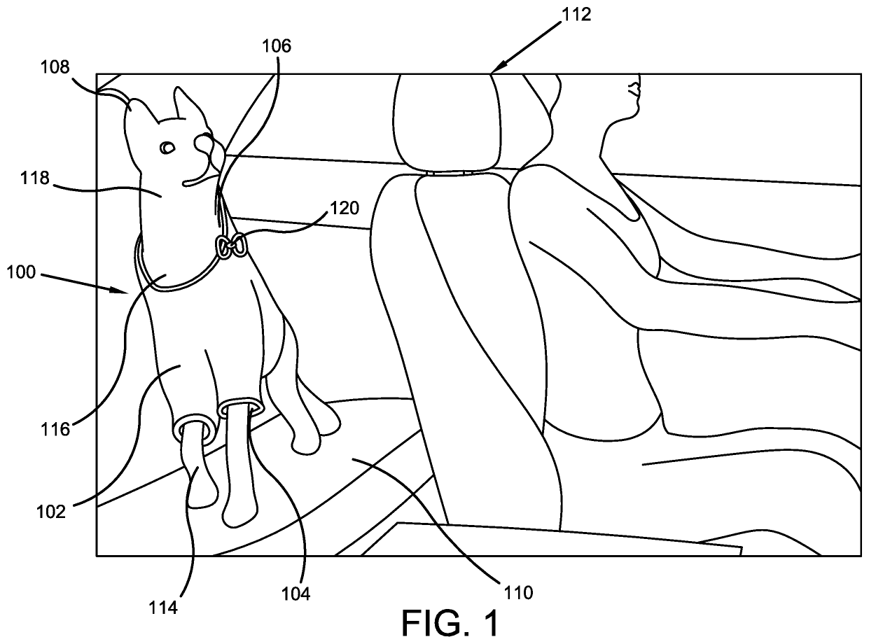

Referring initially to the drawings, FIG. 1 illustrates a perspective view of one embodiment of the pet cover device 100 of the present invention. In the present embodiment, the pet cover device 100 is an improved pet cover device 100 that allows pet owners to travel worry free with their dogs, while maintaining a clean, sanitary vehicle with minimal cleaning required. Specifically, the device 100 is a protective covering for a dog 108 or other pet to prevent the dog 108 or other pet from shedding on vehicle upholstery 110 while traveling in a vehicle 112. The device 100 comprises a bag component 102 with four leg openings 104 and a neck opening 106 for a dog 108 or other pet. The bag component 102 slides up over the dog's legs 114 and torso 116, then up to the dog's neck area 118, where it is tightened with a securing mechanism 120.

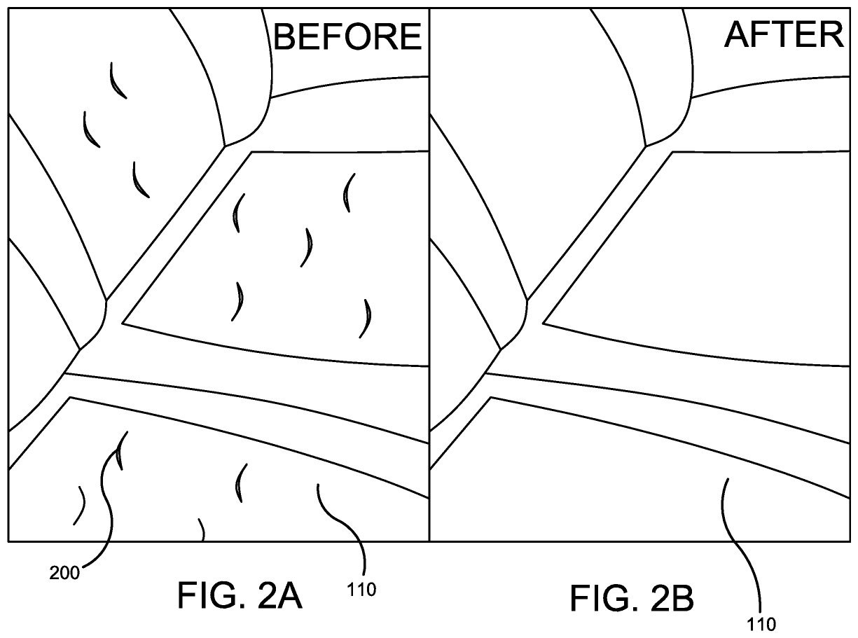

As shown in FIGS. 2A-B, it is common practice to transport dogs 108, cats, and other similar pets in vehicles 112. However, in order to prevent the pets from scratching the upholstery 110 or paint or shedding hairs on the vehicle upholstery 110, a pet cover device 100 is needed which may be quickly placed over the dog 108 or other pet. The pet cover device 100 is comfortable for the pets, and can accommodate pets of varying sizes and weights, within certain limitations of size, due to the fact that the pet cover device 100 is stretchable therein. Specifically, as shown in FIG. 2A, a vehicle seat after transporting a dog 108 or other pet is typically covered with pet hair 200 on the upholstery 110. However, if the pet cover device 100 is used, the seat upholstery 110 is free of pet hair 200, as shown in FIG. 2B. Thus, the pet cover device 100 allows all shed hair to be collected inside the device 100 for easy disposal once traveling is complete. Once traveling is complete, the device 100 is removed from the dog 108 or other pet and the pet hair 200 disposed of.

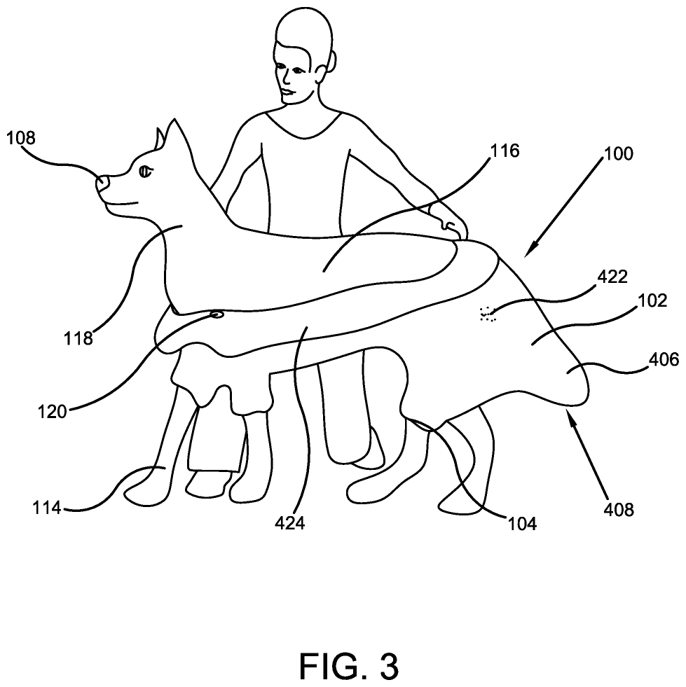

As shown in FIG. 3, the pet cover device 100 comprises a bag component 102 which forms a substantially tubular casing for the dog 108 or other pet. The bag component 102 further comprises four leg openings 104 through which the front and rear legs 114, respectively, of the dog 108 or other pet may extend. Typically, the leg openings 104 extend a few inches down the dog's or other pet's legs 114. However, the leg openings 104 can be any suitable length as is known in the art, depending on the needs and/or wants of a user. In one embodiment, the leg openings 104 extend down the entire length of the dog's or other pet's legs 114.

Furthermore, the leg openings 104 comprise elastic portions 300 around the opening perimeter 302, such that the bag component 102 remains gathered at the dog's legs 114 to remain tight fitting or formed to the dog's legs 114 when in use. The result of this construction is that when the bag component 102 is placed upon the dog 108 and the leg openings 104 pulled up over the feet, the elastic portions 300 will act as cuffs to encircle the dog's legs 114 with sufficient tension to be comfortable, yet keep the lower portion of the leg cover/opening 104 around the leg 114 of the dog 108. The elastic portion 300 also allows the bag component 102 to stretch to accommodate dogs 108 of various lengths, sizes, and shapes. Thus, when the bag component 102 is placed on the dog 108, the dog 108 remains comfortable. Further, the leg openings 104 with the elastic portions 300 do not permit the leg coverings/openings 104 to drop off the dog 108, but still provide the dog 108 with full freedom of movement.

In one embodiment, the leg openings 104 comprise a foot covering 304 which encapsulates the dog's entire foot 306. The foot coverings 304 are designed to be detachable from the leg openings 104 or can be a unitary structure with the bag component 102/leg openings 104 and not capable of being removed. The foot coverings 304 cover the animal's feet 306, such that the claws don't scratch the vehicle seats or paint. On an underside 308 of the foot coverings 304 can also be a tread 310 or other suitable roughened surface topography to allow the pet traction while wearing the foot coverings 304 and not slip.

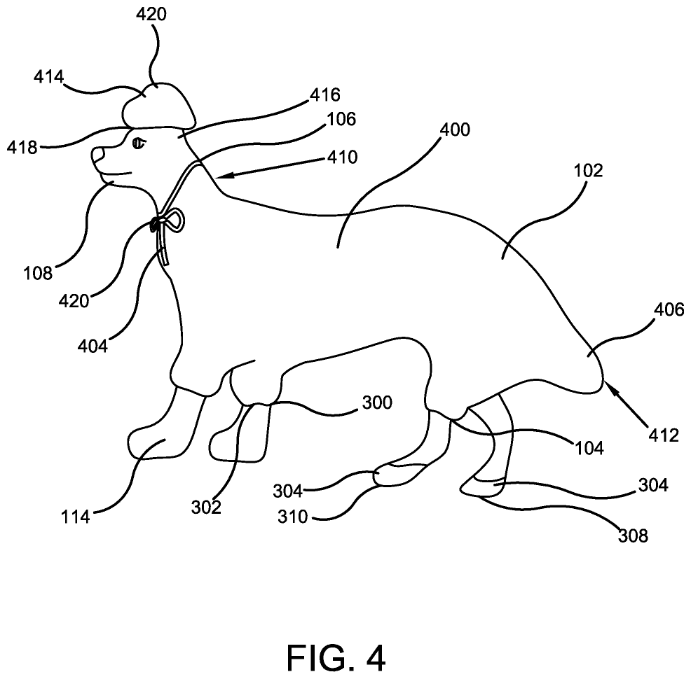

As shown in FIG. 4, the bag component 102 comprises a pliable, plastic cover comprising a body portion 400, terminating at one (or first) end 410 in a neck opening 106 arranged to be secured around a dog's neck 118. The neck opening 106 typically comprises an elastic drawstring 402 and/or hook and loop fasteners 404 which allow a user to secure the neck opening 106 around the neck 118 of a dog 108 or other pet. Further, any suitable fasteners 120 can be utilized depending on the needs and/or wants of a user. Further, the opposite (or second) end 412 of the bag component 102 comprises an extension 406 for receiving the tail 408 of an animal.

In one embodiment, the neck opening 106 comprises a hood portion 414 for covering the head 416 of a dog 108 or other pet. The hood portion 414 is designed to be detachable from the neck opening 106 or can be a unitary structure with the bag component 102 and not capable of being removed. The hood portion 414 can also have an elastic element 418 around its periphery 420 to help in retaining the hood 414 to the dog's head 416.

In operation, the bag component 102 has an outer surface 422 and an inner surface 424, as well as a front (or first) end 410 and a rear (or second) end 412. When the dog 108 steps into the bag component 102, the dog 108 places its legs 114 through the leg openings 104, the tubular rear portion 412 of the bag component 102 then extends around the hindquarters of the body 116 of the dog 108. The tail 408 extends through the extension 406 of the bag component 102, and the bag component 102 then slides over the dog's body/torso 116 up to the neck area 118. In this position, the bag component 102 encapsulates the dog's body 116 and is secured at the neck 118 via a drawstring 402, hook and loop fasteners 404, or other suitable fasteners 120 as is known in the art. Thus, the bag component 102 allows shed hair 200 to be collected inside the bag component 102 for easy disposal once traveling is complete.

Furthermore, the bag component 102 of the device 100 is particularly advantageous due to its flexibility, water-proof quality, and ease of application to and removal from the dog 108. Thus, with the fasteners 120 open around the neck area 118, it is a simple matter to insert the legs 114 of the dog 108 into the open bag component 102, and with a small amount of training, the dog 108 can assist in this operation. It is then only necessary to pull the drawstring 402 or fasteners 120 closed. Removal is even easier, since after separation of the drawstring 402, the bag component 102 may be moved downwardly and rearwardly off the top of the body 116 and then the legs 114 are moved out of the leg openings 104. Again, with a minimal amount of training, the dog 108 can facilitate this operation and can step out of the bag component 102.

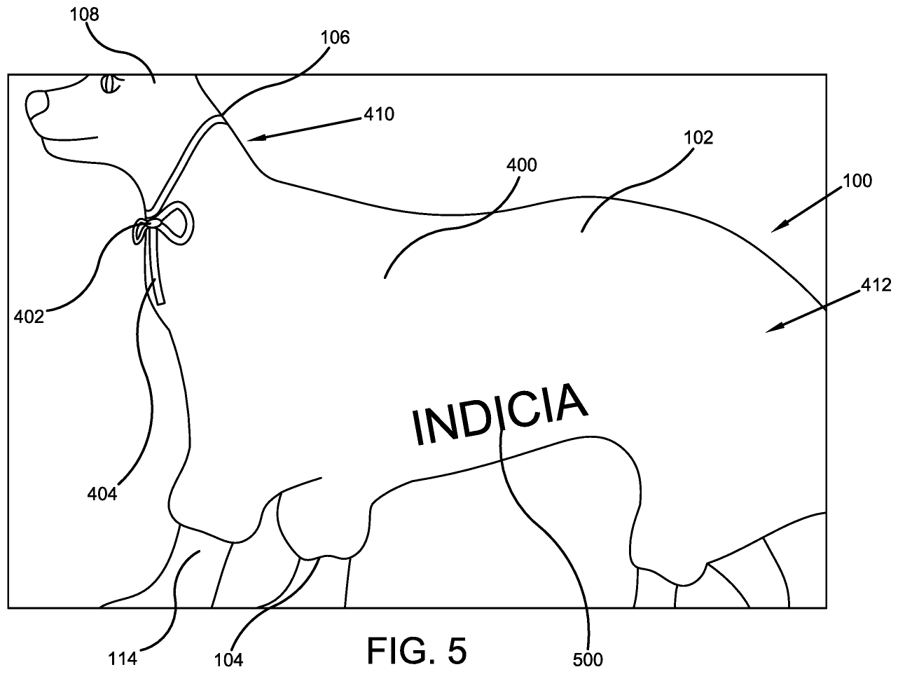

As shown in FIG. 5, the pet cover device 100 is composed of a flexible material, such as a paper material or a plastic material, such as polyethylene, ABS, PVC, etc., or any other suitable materials as is known in the art. Further, it can be composed of an absorbent paper material on the external surface 422, and may have an inner polymeric liner located within the interior surface 424 for mitigating the risk of leakage of liquid onto the vehicle seats should the animal urinate while wearing the device 108. If the pet cover device 100 is composed of a polymeric material, such as a thin plastic material, it should be recyclable in nature. Most preferably, the pet cover device 100 is composed of a biodegradable fiber, so that the disposable sanitary pet cover device 100 is lightweight, easy to use, and environmentally friendly.

Furthermore, the pet cover device 100 can be a variety of shapes and sizes and can be made from a variety of materials. In some embodiments, the pet cover device 100 can be sized and shaped to fit over small dogs and other pets. In other embodiments, the pet cover device 100 can be sized and shaped to fit over large dogs and other pets. Typically, the pet cover device 100 would be manufactured in small, medium, and large sizes to fit most animals. In some embodiments, the pet cover device 100 can be made of an antimicrobial material to form a bacterial barrier. In one embodiment, for example, the pet cover device 100 can be made of a fabric that can be flexible, elastic, and antimicrobial such as, for example, poly spandex.

In one embodiment, the pet cover device 100 is provided in a sealed container packaged prior to use in a clean environment. In this regard, the pet cover device 100 is preferably disposed of after a single usage. In another embodiment, the pet cover device 100 can be reusable. In this embodiment, the pet cover device 100 is manufactured of a fabric material that allows the pet cover device 100 to be washed and reused.

In yet another embodiment, the pet cover device 100 comprises a plurality of indicia. The bag component 102 of the device 100 may include advertising, trademark, or other letters, designs, or characters, printed, painted, stamped, or integrated into the bag component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be pet or brand related.

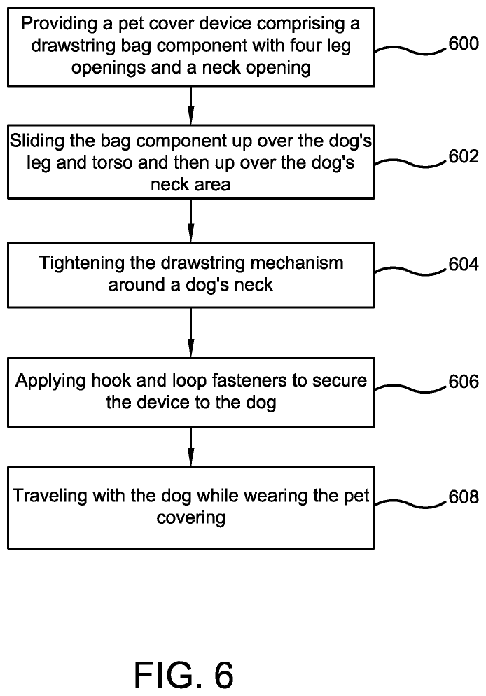

FIG. 6 illustrates a flowchart of the method of traveling with a pet while still maintaining a clean, sanitary vehicle. The method includes the steps of at 600, providing a pet cover device comprising a drawstring bag component with four leg openings and a neck opening. The method also comprises at 602, sliding the bag component up over the dog's legs and torso and then up to the dog's neck area. Further, the method comprises at 604, tightening the drawstring mechanism around a dog's neck. The method also comprises at 606, applying hook and loop fasteners to secure the device to the dog. Finally, the method comprises at 608, traveling with the dog while wearing the pet cover device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet cover device”, “pet device”, and “device” are interchangeable and refer to the pet cover device 100 of the present invention.

Notwithstanding the foregoing, the pet cover device 100 of the present invention can be of any suitable size and configuration as is known in the art without affecting the overall concept of the invention, provided that it accomplishes the above-stated objectives. One of ordinary skill in the art will appreciate that the pet cover device 100 as shown in FIGS. 1-6 are for illustrative purposes only, and that many other sizes and shapes of the pet cover device 100 are well within the scope of the present disclosure. Although the dimensions of the pet cover device 100 are important design parameters for user convenience, the pet cover device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet cover device that allows a pet owner to travel worry free with a pet while maintaining a clean vehicle, the pet cover device comprising:
a bag component;
a set of four leg openings in the bag component, wherein each of the set of four leg components are sized and configured to accommodate a leg of the pet;
a neck opening in the bag component, wherein the neck opening is sized and configured to accommodate a neck of the pet; and
a securing mechanism, wherein the bag component slides over the legs and a torso of the pet, then up to the neck of the pet before being secured to the pet via the securing mechanism.

2. The pet cover device of claim 1, wherein each of the set of four leg openings comprise an elastic portion around an opening perimeter to remain tight fitting to the leg of the pet.

3. The pet cover device of claim 2 further comprising a foot covering that encapsulates a foot of the pet.

4. The pet cover device of claim 3, wherein the foot covering is detachable from a respective one of the set of four leg openings.

5. The pet cover device of claim 4, wherein an underside of the foot covering comprises a tread.

6. The pet cover device of claim 5, wherein the bag component comprises a body portion extending from the neck opening to an extension for receiving a tail of the pet.

7. The pet cover device of claim 6, wherein the neck opening comprises an elastic drawstring and a plurality of hook and loop fasteners.

8. The pet cover device of claim 7, wherein the neck opening comprises a hood portion for covering a head of the pet.

9. The pet cover device of claim 8, wherein the hood portion is detachable from the neck opening.

10. The pet cover device of claim 9, wherein the hood portion comprises an elastic element around a periphery.

11. The pet cover device of claim 10 further comprising an external surface and an inner polymeric liner located within the bag component for mitigating risk of leakage of a liquid from the bag component.

12. The pet cover device of claim 11, wherein the liquid is a pet urine.

13. The pet cover device of claim 12, wherein the pet cover device is disposable.

14. The pet cover device of claim 13, wherein the pet cover device is reusable.

15. A pet cover device that allows a pet owner to travel worry free with a pet while maintaining a clean vehicle, the pet device comprising:
a bag component;
a set of four leg openings in the bag component, wherein each of the set of four leg components are sized and configured to accommodate a leg of the pet;
a neck opening in the bag component, wherein the neck opening is sized and configured to accommodate a neck of the pet; and
a securing mechanism;
wherein the bag component slides over the legs and a torso of the pet, then up to the neck of the pet before being secured to the pet via the securing mechanism;
wherein each of the set of four leg openings comprises an elastic portion around an opening perimeter to remain tight fitting to a pet's leg;
wherein the bag component comprises a body portion terminating at a first end in the neck opening and a second end in an extension for receiving a tail; and
wherein the neck opening comprises an elastic drawstring and a plurality of hook and loop fasteners.

16. The pet cover device of claim 15 further comprising a plurality of indicia.

17. The pet cover device of claim 15, wherein the pet cover device is disposable.

18. The pet cover device of claim 15, wherein the pet cover device is reusable.

19. The pet cover device of claim 15, wherein the pet cover device comprises an external surface and an inner polymeric liner located within the bag component for mitigating risk of leakage of a liquid.

20. A method of traveling with a pet while maintaining a clean sanitary vehicle, the method comprising the following steps:
providing a pet cover device comprising a drawstring bag component having a set of four leg openings and a neck opening;
sliding the bag component up over the pet's leg and torso and then up to the pet's neck;
tightening the drawstring mechanism around the pet's neck;
applying a plurality of hook and loop fasteners to secure the pet cover device to the pet; and
traveling with the pet while wearing the pet cover device.
